(19) United States
(12) Patent Application Publication
(10) Pub. No.: US 2017/0335077 A1
(43) Pub. Date: Nov. 23, 2017

(54) HIGH MODULUS SINGLE-SITE LLDPE

(71) Applicant: NOVA CHEMICALS (INTERNATIONAL) S.A., Fribourg (CH)

(72) Inventors: Nitin BORSE, Calgary (CA); Norman AUBEE, Okotoks (CA); P. Scott CHISHOLM, Calgary (CA)

(73) Assignee: NOVA Chemicals (International) S.A., Fribourg (CH)

(21) Appl. No.: 15/533,046

(22) PCT Filed: Dec. 11, 2015
(86) PCT No.: PCT/IB2015/059559

§ 371 Date: Jun. 5, 2017

(30) Foreign Application Priority Data
Dec. 16, 2014 (CA) 2874895

(51) Int. Cl. C08J 5/18; C08L 23/06; B29C 49/00; B29L 7/00; B29K 23/00

(52) U.S. Cl. CPC C08J 5/18; C08L 23/06; B29C 49/0005; C08L 2205/24; C08L 2205/025; C08L 2203/16; B29K 2023/0625; C08L 2207/066; C08J 2323/06; B29L 2007/008; B29K 2023/065; C08L 2207/062; C08J 2423/06

(57) ABSTRACT

Linear low density polyethylene (LLDPE) that is prepared with a single site catalyst has relatively low modulus in comparison to a polyethylene of similar melt index and density made with a conventional Zeigler Natta catalyst. Films that are prepared from polyethylene having a low modulus have a soft and flexible “feel”, which is undesirable for some packaging applications. The present invention provides a method to increase the modulus of single site catalyzed polyethylene.

### TECHNICAL FIELD

A blend of single site catalyzed polyethylene with a small amount of high density polyethylene and a nucleating agent provides films having improved modulus.

### BACKGROUND ART

There are two general types of polyethylene, namely low density polyethylene that is prepared in a high pressure process using a free radical initiator (commonly referred to as “LD” polyethylene) and linear polyethylene that is prepared with a transition metal catalyst (commonly referred to as “linear” polyethylene).

Linear polyethylene generally has superior physical properties in comparison to LD polyethylene.

Conventional linear polyethylene is typically prepared with a Zeigler-Natta (Z/N) catalyst or a chromium (Cr) catalyst. Such catalysts produce polymers having comparatively broad molecular weight distributions (MWD) and (in the case of copolymers) comparatively broad comonomer distributions.

More recently, so-called “single site” catalysts (such as metallocene catalysts) have been put into commercial use. These catalysts enable the production of polyethylene having a uniform polymer structure—especially a narrow molecular weight distribution (MWD) and a narrow composition distribution. In general, these polymers have exceptional puncture resistance.

However, these polymers generally produce films having low modulus. Low modulus can be a disadvantage in some packaging applications—especially the so called vertical form fill and seal packages and stand up pouches. In addition, “soft” films generally feel thinner than films having a higher modulus and this is viewed as a negative by many consumers. This invention mitigates these disadvantages.

### DISCLOSURE OF THE INVENTION

The present invention provides a method to improve the stiffness of a polyethylene film, said method comprising providing a composition comprising
1) a polyethylene blend comprising

a) from 90 to 98 weight % of a linear low density polyethylene composition that has been prepared with a single site catalyst; and

b) from 10 to 2 weight % of high density polyethylene composition; and

2) from 200 to 10,000 parts per million by weight, based on the weight on said polyethylene blend, of a nucleating agent,

and subjecting said composition to a film molding process, wherein said film has a higher 1% secant modulus than a film that is prepared with said polyethylene blend but in the absence of said nucleating agent.

In another embodiment, the present invention provides a composition comprising:
1) a polyethylene blend comprising:

a) from 90 to 98 weight % of a linear low density polyethylene composition that is prepared with a single site catalyst, wherein said linear low density polyethylene composition has a melt index, 12, of from 0.2 to 10 g/10 minutes and a density of from 0.905 to 0.935 g/cc; and

b) from 10 to 2 weight % of a high density polyethylene composition, wherein said high density polyethylene composition has a melt index, 12, of from 0.1 to 10 g/10 minutes and a density of from 0.95 to 0.97 g/cc; and
2) from 200 to 10,000 parts per million by weight, based on the weight of said polyethylene blend, of a nucleating agent.

The invention enables the production of “stiffer” films from single-site catalyzed linear low density polyethylene. The increased stiffness (as evidenced by a higher 1% secant modulus) allows the films to be down gauged (i.e. made thinner) in certain applications.

In general, the films may be produced in any film molding process. The so called “cast film process” and blown film process are in wide commercial use and are well known to those skilled in the art.

The present invention is particularly suitable for in the blown film process, as illustrated in the examples.

The films of this invention are suitable for use as a monolayer or as a component of a multilayer structure. The film provides a good balance of impact resistance, stiffness (modulus) and sealing characteristics. They are suitable for use as a sealant layer, a core layer, or an abuse resistant skin layer in a multilayer structure.

### BEST MODE FOR CARRYING OUT THE INVENTION

### Part A Single Site Catalyzed Linear Low Density Polyethylene Composition

The linear low density polyethylene composition (LLDPE composition) contains at least one linear low density polyethylene that is prepared with a single site catalyst. In one embodiment, this composition has a narrow composition (as defined by having a Composition Distribution Branch Index, CDBI, of at greater than about 70%, as described below), a melt index (1₂, as determined by ASTM D 1238) is in the range of from 0.2 to 10 grams/10 minutes, especially from 0.5 to 5 grams/10 minutes and a density of from 0.905 to 0.935 g/cc (especially from 0.905 to 0.925 g/cc); and a molecular weight distribution (Mw/Mn) of from about 2 to 6 (especially 2 to 4). Such polyethylenes are known items of commerce and may be prepared with a so-called single site catalyst (such as a metallocene catalyst). In one embodiment, the linear low density polyethylene composition is made with two or more catalysts (of which at least one is a single site catalyst) in two or more polymerization reactors.

The composition distribution of polyethylene can be characterized by the SCBDI (Short Chain Branch Distribution Index) or CDBI (Composition Distribution Branch Index). The CBDI is defined as the weight percent of the polymer molecules having a comonomer content within 50 percent of the median total molar comonomer content. The CDBI of a polymer is readily calculated from data obtained from techniques known in the art, such as, for example, temperature rising elution fractionation (abbreviated herein as “TREF”) as described, for example, in Wild et al, Journal of Polymer Science, Poly. Phys. Ed. Vol. 20, p. 441 (1982), or in U.S. Pat. No. 4,798,081. The CDBI for the LLDPE compositions of the present invention is preferably greater than about 60%, especially greater than about 70%.

The linear low density polyethylene used in the present invention are copolymers of ethylene with at least one C3-C20 alpha-olefin and/or C₄-C₁₈ diolefins. Homogeneous copolymers of ethylene and propylene, butene-1, hexene-1, 4-methyl-1-pentene and octene-1 are preferred (and copolymers of ethylene and 1-octene are especially preferred).

It is within the scope of this invention to use a blend of more than one single site catalyzed polyethylene. A combination of a single site catalyst and a Ziegler Natta catalyst may also be employed.

In one embodiment of this invention, a “dual reactor” polymerization process is used to broaden the molecular weight distribution (“MWD”) of the linear low density compositions. As used herein, the term MWD refers to the ration of weight average molecular weight (Mw) divided by number average molecular weight (Mn).

### Description of Single Site Catalyst

The term “single site catalyst” as used herein is meant to convey its conventional meaning, namely, a catalyst that produces a polyethylene having a narrow molecular weight distribution and (in the case of copolymers), a uniform comonomer distribution.

A further description of the single site catalyst follows.

In general, any transition metal catalyst compound which is activated by an aluminum alkyl or methyl aluminoxane (MAO), or an “ionic activator” is potentially suitable for use in the single site catalyst. An extensive discussion of such catalysts is provided in U.S. Pat. No. 6,720,396 (Bell et al.; assigned to Univation Technologies) and the references cited therein. A general (non-limiting) overview of such catalyst compounds follows. Such catalysts typically contain a “bulky” functional ligand. Preferred catalyst compounds are group 4 metal complexes (especially titanium or zirconium) which contain one cyclopentadienyl ligand (“homocyclopentadienyl complexes”) or two cyclopentadienyl ligands (“biscyclopentadienyl complexes”).

The bulky ligands are generally represented by one or more open, acyclic, or fused ring(s) or ring system(s) or a combination thereof. The ring(s) or ring system(s) of these bulky ligands are typically composed of atoms selected from Groups 13 to 16 atoms of the Periodic Table of Elements. Preferably the atoms are selected from the group consisting of carbon, nitrogen, oxygen, silicon, sulfur, phosphorous, germanium, boron and aluminum or a combination thereof. Most preferably the ring(s) or ring system(s) are composed of carbon atoms such as but not limited to those cyclopentadienyl ligands or cyclopentadienyl-type ligand structures or other similar functioning ligand structure such as a pentadiene, a cyclooctatetraendiyl or an imide ligand. The metal atom is preferably selected from Groups 3 through 15 and the lanthanide or actinide series of the Periodic Table of Elements. Preferably the metal is a transition metal from Groups 4 through 12, more preferably Groups 4, 5 and 6, and most preferably the transition metal is from Group 4.

In one embodiment, catalyst compounds are represented by the formula:

LALBMQn (I)

where M is a metal atom from the Periodic Table of the Elements and may be a Group 3 to 12 metal or from the lanthanide or actinide series of the Periodic Table of Elements, preferably M is a Group 4, 5 or 6 transition metal, more preferably M is zirconium, hafnium or titanium. The bulky ligands, LA and LB, are open, acyclic or fused ring(s) or ring system(s) and are any ancillary ligand system, including unsubstituted or substituted, cyclopentadienyl ligands or cyclopentadienyl-type ligands, heteroatom substituted and/or heteroatom containing cyclopentadienyl-type ligands. Non-limiting examples of bulky ligands include cyclopentadienyl ligands, cyclopentaphenanthreneyl ligands, indenyl ligands, benzindenyl ligands, fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine, pyrrolyl ligands, pyrozolyl ligands, carbazolyl ligands, borabenzene ligands and the like, including hydrogenated versions thereof, for example tetrahydroindenyl ligands. In one embodiment, LA and LB may be any other ligand structure capable of .eta.-bonding to M, preferably .eta.3-bonding to M and most preferably .eta.5-bonding. In another embodiment, LA and LB may comprise one or more heteroatoms, for example, nitrogen, silicon, boron, germanium, sulfur and phosphorous, in combination with carbon atoms to form an open, acyclic, or preferably a fused, ring or ring system, for example, a hetero-cyclopentadienyl ancillary ligand. Other LA and LB bulky ligands include but are not limited to bulky amides, phosphides, alkoxides, aryloxides, phosphinimides, imides, carbolides, borollides, porphyrins, phthalocyanines, corrins and other polyazomacrocycles. Independently, each LA and LB may be the same or different type of bulky ligand that is bonded to M. In one embodiment of formula (I) only one of either LA or LB is present.

Independently, each LA and LB may be unsubstituted or substituted with a combination of substituent groups R. Non-limiting examples of substituent groups R include one or more from the group selected from hydrogen, or linear, branched alkyl radicals, or alkenyl radicals, alkynyl radicals, cycloalkyl radicals or aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl- carbamoyl radicals, acyloxy radicals, acylamino radicals, aroylamino radicals, straight, branched or cyclic, alkylene radicals, or combination thereof. In a preferred embodiment, substituent groups R have up to 50 non-hydrogen atoms, preferably from 1 to 30 carbon that can also be substituted with halogens or heteroatoms or the like. Non-limiting examples of alkyl substituents R include methyl, ethyl, propyl, butyl, pentyl, hexyl, cyclopentyl, cyclohexyl, benzyl or phenyl groups and the like, including all their isomers, for example tertiary butyl, isopropyl, and the like. Other hydrocarbyl radicals include fluoromethyl, fluroethyl, difluroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)-silyl, methyl-bis(difluoromethyl)silyl, bromomethyldimethylgermyl and the like; and disubstituted boron radicals including dimethylboron for example; and disubstituted heteroatom radicals including dimethylamine, dimethylphosphine, diphenylamine, methylphenylphosphine, chalcogen radicals including methoxy, ethoxy, propoxy, phenoxy, methylsulfide and ethylsulfide. Non-hydrogen substituents R include the atoms carbon, silicon, boron, aluminum, nitrogen, phosphorous, oxygen, tin, sulfur, germanium and the like, including olefins such as but not limited to olefinically unsaturated substituents including vinyl-terminated ligands, for example but-3-enyl, prop-2-enyl, hex-5-enyl and the like. Also, at least two R groups, preferably two adjacent R groups, are joined to form a ring structure having from 3 to 30 atoms selected from carbon, nitrogen, oxygen, phosphorous, silicon, germanium, aluminum, boron or a combination thereof. Also, a substituent group R group such as 1-butanyl may form a carbon sigma bond to the metal M.

Other ligands may be bonded to the metal M, such as at least one leaving group Q. As used herein the term “leaving group” is any ligand that can be abstracted from a bulky ligand catalyst compound to form a bulky ligand catalyst species capable of polymerizing one or more olefin(s). In one embodiment, Q is a monoanionic labile ligand having a sigma-bond to M. Depending on the oxidation state of the metal, the value for n is 0, 1 or 2 such that formula (I) above represents a neutral bulky ligand catalyst compound.

Non-limiting examples of Q ligands include weak bases such as amines, phosphines, ethers, carboxylates, dienes, hydrocarbyl radicals having from 1 to 20 carbon atoms, hydrides or halogens and the like or a combination thereof. In another embodiment, two or more Q's form a part of a fused ring or ring system. Other examples of Q ligands include those substituents for R as described above and including cyclobutyl, cyclohexyl, heptyl, tolyl, trifluromethyl, tetramethylene, pentamethylene, methylidene, methyoxy, ethyoxy, propoxy, phenoxy, bis(N-methylanilide), dimethylamide, dimethylphosphide radicals and the like.

In another embodiment, the catalyst compound is represented by the following formula:

LAALBMQn (II)

These compounds represented by formula (II) are known as bridged, ligand catalyst compounds. LA, LB, M, Q and n are as defined above. Non-limiting examples of bridging group A include bridging groups containing at least one Group 13 to 16 atom, often referred to as a divalent moiety such as but not limited to at least one of a carbon, oxygen, nitrogen, silicon, aluminum, boron, germanium and tin atom or a combination thereof. Preferably bridging group A contains a carbon, silicon or germanium atom, most preferably A contains at least one silicon atom or at least one carbon atom. The bridging group A may also contain substituent groups R as defined above including halogens and iron. Non-limiting examples of bridging group A may be represented by R′2C, R′2Si, R′2Si R′2Si, R′2Ge, R′P, where R′ is independently, a radical group which is hydride, hydrocarbyl, substituted hydrocarbyl, halocarbyl, substituted halocarbyl, hydrocarbyl-substituted organometalloid, halocarbyl-substituted organometalloid, disubstituted boron, substituted chalcogen, or halogen or two or more R′ may be joined to form a ring or ring system. In one embodiment, the bridged, ligand catalyst compounds of formula (II) have two or more bridging groups A.

In one embodiment, the catalyst compounds are those where the R substituents on the bulky ligands LA and LB of formulas (I) and (II) are substituted with the same or different number of substituents on each of the bulky ligands. In another embodiment, the bulky ligands LA and LB of formulas (I) and (II) are different from each other.

In a most preferred embodiment, catalyst compounds useful in the invention include bridged heteroatom, mono-bulky ligand compounds. More specifically, these highly preferred catalysts are group 4 metal (especially titanium) complexes characterized by having a bridged, bidentate cyclopentadienyl-amine ligand, as disclosed in the aforementioned U.S. Pat. No. 5,047,475. Preferred bridging groups are dialkyl silyls—especially dimethyl silyl. The amine portion of the ligand preferably has an alkyl substituent on the nitrogen atom (especially tertiary butyl) with the remaining nitrogen bands bonding to the transition metal (preferably titanium) and the silicon atome of the preferred dimethyl silyl bridging group. The cyclopentadienyl ligand is pi-bonded to the transition metal and covalently bonded to the bridging group. The cyclopentadienyl group is preferably substituted, especially tetra methyl cyclopentadienyl.

Preferred catalyst compounds include dimethylsilyltetramnethyl cyclopentadienyl-tertiary butyl amido titanium di chloride (and the alkyl analogues—i.e. with the two chloride ligands being replaced by simple alkyls, especially methyl).

In another embodiment, the catalyst compound is represented by the formula:

LCAJMQn (III)

where M is a Group 3 to 16 metal atom or a metal selected from the Group of actinides and lanthanides of the Periodic Table of Elements, preferably M is a Group 4 to 12 transition metal, and more preferably M is a Group 4, 5 or 6 transition metal, and most preferably M is a Group 4 transition metal in any oxidation state, especially titanium; LC is a substituted or unsubstituted bulky ligand bonded to M; J is bonded to M; A is bonded to M and J; J is a heteroatom ancillary ligand; and A is a bridging group; Q is a univalent anionic ligand; and n is the integer 0, 1 or 2. In formula (III) above, LC, A and J may form a fused ring system. In an embodiment, LC of formula (III) is as defined above for LA in formula (I) and A, M and Q of formula (III) are as defined above in formula (I).

In formula (III) J is a heteroatom containing ligand in which J is an element with a coordination number of three from Group 15 or an element with a coordination number of two from Group 16 of the Periodic Table of Elements. Preferably J contains a nitrogen, phosphorus, oxygen or sulfur atom with nitrogen being most preferred.

In another embodiment, catalyst compound is a complex of a metal, preferably a transition metal, a bulky ligand, preferably a substituted or unsubstituted pi-bonded ligand, and one or more heteroallyl moieties, such as those described in U.S. Pat. No. 5,527,752.

In another embodiment, the catalyst compounds are represented by the formula:

LDMQ2(YZ)Xn (IV)

where M is a Group 3 to 16 metal, preferably a Group 4 to 12 transition metal, and most preferably a Group 4, 5 or 6 transition metal; LD is a bulky ligand that is bonded to M; each Q is independently bonded to M and Q2(YZ) forms a unicharged polydentate ligand; A or Q is a univalent anionic ligand also bonded to M; X is a univalent anionic group when n is 2 or X is a divalent anionic group when n is 1; n is 1 or 2.

In formula (IV), L and M are as defined above for formula (I). Q is as defined above for formula (I), preferably Q is selected from the group consisting of —O—, —NR—, —CR2- and —S—. Y is either C or S. Z is selected from the group consisting of —OR, —NR2, —CR3, —SR, —SiR3, —PR2, —H, and substituted or unsubstituted aryl groups, with the proviso that when Q is —NR— then Z is selected from one of the group consisting of —OR, —NR2, —SR, —SiR3, —PR2 and —H; R is selected from a group containing carbon, silicon, nitrogen, oxygen, and/or phosphorus, preferably where R is a hydrocarbon group containing from 1 to 20 carbon atoms, most preferably an alkyl, cycloalkyl, or an aryl group; n is an integer from 1 to 4, preferably 1 or 2; X is a univalent anionic group when n is 2 or X is a divalent anionic group when n is 1; preferably X is a carbamate, carboxylate, or other heteroallyl moiety described by the Q, Y and Z combination.

In another embodiment of the invention, the catalyst compounds are heterocyclic ligand complexes where the bulky ligands, the ring(s) or ring system(s), include one or more heteroatoms or a combination thereof. Non-limiting examples of heteroatoms include a Group 13 to 16 element, preferably nitrogen, boron, sulfur, oxygen, aluminum, silicon, phosphorous and tin. Examples of these bulky ligand catalyst compounds are described in U.S. Pat. No. 5,637,660.

In one embodiment, the catalyst compounds are represented by the formula:

((Z)XAt(YJ))qMQn (V)

where M is a metal selected from Group 3 to 13 or lanthanide and actinide series of the Periodic Table of Elements; Q is bonded to M and each Q is a monovalent, bivalent, or trivalent anion; X and Y are bonded to M; one or more of X and Y are heteroatoms, preferably both X and Y are heteroatoms; Y is contained in a heterocyclic ring J, where J comprises from 2 to 50 non-hydrogen atoms, preferably 2 to 30 carbon atoms; Z is bonded to X, where Z comprises 1 to 50 non-hydrogen atoms, preferably 1 to 50 carbon atoms, preferably Z is a cyclic group containing 3 to 50 atoms, preferably 3 to 30 carbon atoms; t is 0 or 1; when t is 1, A is a bridging group joined to at least one of X, Y or J, preferably X and J; q is 1 or 2; n is an integer from 1 to 4 depending on the oxidation state of M. In one embodiment, where X is oxygen or sulfur then Z is optional. In another embodiment, where X is nitrogen or phosphorous then Z is present. In an embodiment, Z is preferably an aryl group, more preferably a substituted aryl group.

It is also within the scope of this invention, in one embodiment, that the catalyst compounds include complexes of Ni2+ and Pd2+ described in U.S. Pat. No. 5,852,145. These complexes can be either dialkyl ether adducts, or alkylated reaction products of the described dihalide complexes that can be activated to a cationic state by the activators or cocatalysts are described below.

Also included as catalyst compounds are those diimine based ligands of Group 8 to 10 metal compounds.

Other suitable catalyst compounds are those Group 5 and 6 metal imido complexes described in U.S. Pat. No. 5,851,945. In addition, bulky ligand catalyst compounds include bridged bis(arylamido) Group 4 compounds, bridged bis(amido) catalyst compounds and catalysts having bis(hydroxy aromatic nitrogen ligands).

It is also contemplated that in one embodiment, the catalyst compounds of the invention described above include their structural or optical or enantiomeric isomers (meso and racemic isomers) and mixtures thereof.

Other catalyst compounds useful in this invention are disclosed in the aforementioned U.S. Pat. No. 6,720,396 (and references therein).

Highly preferred catalyst compounds are group IV metal compounds which contain at least one cyclopentadienyl ligand.

### C. Activation

The above described transition metal catalysts are utilized for olefin polymerization in the presence of a cocatalyst or activator.

Aluminoxanes, especially methyl aluminoxane, are well known cocatalyst for organometallic catalyst compounds. Methyl aluminoxane, and near variants thereof (which typically contain small levels of higher alkyl groups) are commercially available products. Although the exact structure of these aluminoxanes is still somewhat uncertain, it is generally agreed that they are oligomeric species that contain repeating units of the general formula:

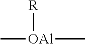

where R is (predominantly) methyl.

It is also well known to employ so-called “ionic activators” (also referred to herein as activator compounds) with organometallic catalyst compounds, as described in U.S. Pat. No. 5,198,401 (Hlatky and Turner) and U.S. Pat. No. 5,132,380 (Stevens and Neithamer). In general, these activators comprise a cation and a substantially non-coordinating anion.

Whilst not wishing to be bound by any theory, it is thought by many of those skilled in the art that boron activators initially cause the abstraction of one or more of the activatable ligands in a manner which ionizes the catalyst into a cation, then provides a bulky, labile, non-coordinating anion which stabilizes the catalyst in a cationic form. The resulting bulky, non-coordinating anion permits olefin polymerization to proceed at the cationic catalyst center (presumably because the non-coordinating anion is sufficiently labile to be displaced by monomer which coordinates to the catalyst. It should be expressly noted that the boron activator/phosphinimine catalyst may also form a non-ionic coordination complex which is catalytically active for olefin polymerization. The boron activator is described as being four coordinate—i.e. there must be four ligands bonded to the boron atom. Preferred boron activators are described in (i)-(ii) below:
(i) compounds of the formula [R5]+[B(R7)4]- wherein B is a boron atom, R5 is an aromatic hydrocarbyl (e.g. triphenyl methyl cation) and each R7 is independently selected from the group consisting of phenyl radicals which are unsubstituted or substituted with from 3 to 5 substituents selected from the group consisting of a fluorine atom, a C1-4 alkyl or alkoxy radical which is unsubstituted or substituted by a fluorine atom; and
(ii) compounds of the formula [(R8)t ZH]+[B(R7)4]- wherein B is a boron atom, H is a hydrogen atom, Z is a nitrogen atom or phosphorus atom, t is 2 or 3 and R8 is selected from the group consisting of 01-8 alkyl radicals, a phenyl radical which is unsubstituted or substituted by up to three C1-4 alkyl radicals, or one R8 taken together with the nitrogen atom may form an anilinium radical and R7 is as defined above.

In the above compounds preferably R7 is a pentafluorophenyl radical. In general, preferred boron activators may be described as salts of tetra(perfluorophenyl) boron. More specifically, the preferred activators are anilinium, carbonium, oxonium, phosphonium and sulfonium salts of tetra(perfluorophenyl) boron, with anilinium and trityl (or “triphenyl methylium”) salts being especially preferred.

It should also be noted that three coordinate boron activators (i.e. compounds of the formula B(R7)3 where R7 is as defined above) are not suitable for use in the process of this invention. This is surprising as such compounds are well known as activators for metallocene catalysts. However, for reasons which are not completely understood, the use of a trivalent boron activator is not suitable for preparing polymers having a broad molecular distribution in accordance with the process of this invention.

Exemplary ionic activators include:
triethylammonium tetra(phenyl)boron,
tripropylammonium tetra(phenyl)boron,
tri(n-butyl)ammonium tetra(phenyl)boron,
trimethylammonium tetra(p-tolyl)boron,
trimethylammonium tetra(o-tolyl)boron,
tributylammonium tetra(pentafluorophenyl)boron,
tripropylammonium tetra(o,p-dimethylphenyl)boron,
tributylammonium tetra(m,m-dimethylphenyl)boron,
tributylammonium tetra(p-trifluoromethylphenyl)boron,
tributylammonium tetra(pentafluorophenyl)boron,
tri(n-butyl)ammonium tetra(o-tolyl)boron,
N,N-dimethylanilinium tetra(phenyl)boron,
N,N-diethylanilinium tetra(phenyl)boron,
N,N-diethylanilinium tetra(phenyl)n-butylboron,
N,N-2,4,6-pentamethylanilinium tetra(phenyl)boron,
di-(isopropyl)ammonium tetra(pentafluorophenyl)boron,
dicyclohexylammonium tetra(phenyl)boron,
triphenylphosphonium tetra(phenyl)boron,
tri(methylphenyl)phosphonium tetra(phenyl)boron,
tri(dimethylphenyl)phosphonium tetra(phenyl)boron,
tropillium tetrakispentafluorophenyl borate,
triphenylmethylium tetrakispentafluorophenyl borate,
benzene (diazonium) tetrakispentafluorophenyl borate,
tropillium tetrakis (2,3,5,6-tetrafluorophenyl) borate,
triphenylmethylium tetrakis (2,3,5,6-tetrafluorophenyl) borate,
benzene (diazonium) tetrakis (3,4,5-trifluorophenyl) borate,
tropillium tetrakis (3,4,5-trifluorophenyl) borate,
benzene (diazonium) tetrakis (3,4,5-trifluorophenyl) borate,
tropillium tetrakis (1,2,2-trifluoroethenyl) borate,
triphenylmethylium tetrakis (1,2,2-trifluoroethenyl) borate,
benzene (diazonium) tetrakis (1,2,2-trifluoroethenyl) borate,
tropillium tetrakis (2,3,4,5-tetrafluorophenyl) borate,
triphenylmethylium tetrakis (2,3,4,5-tetrafluorophenyl) borate, and
benzene (diazonium) tetrakis (2,3,4,5-tetrafluorophenyl) borate.

Readily commercially available ionic activators which are suitable for the process of this invention are N,N-dimethylaniliniumtetrakispentafluorophenyl borate, and triphenylmethylium tetrakispentafluorophenyl borate (also known as “trityl borate”).

It is preferred to use the boron activator in an equimolar amount with respect to the transition metal of the catalyst (i.e. boron/titanium ratio of 1/1, when the catalyst is an organotitanium complex) through mole ratios of from 0.3/1 to 10.0/1 may be used.

### High Density Polyethylene (HDPE)

The present invention uses a minor amount of an HDPE composition.

As used herein, the term HDPE refers to a polyethylene having a density of from about 0.94 to 0.97 g/cc. The HDPE may be a homopolymer or a copolymer. In one embodiment, melt index, 12, of the HDPE is from about 0.3 to 20 grams per 10 minutes especially from 1 to 10 grams per 10 minutes. The use of higher molecular weight HDPE (or alternatively stated, HDPE having a lower 12) is not preferred.

HDPE is a widely available item of commerce. Most HDPE is prepared with a catalyst containing a metal selected from the group consisting of chromium and group IV transition metals (Ti; Hf and Zr). The use of HDPE prepared from a group IV metal is preferred.

In one embodiment, the HDPE composition is a blend of two or more HDPE components. An especially suitable method to prepare such blend compositions is disclosed in U.S. Pat. No. 7,737,220 (Swabey et al.).

In one embodiment, the amount of the HDPE composition is as low as from about 2 to about 5 weight %. Highly desirable improvements in modulus are observed even at this low amount of HDPE. In addition, the impact properties of the films prepared from these compositions are better than the impact properties of films prepared with higher amounts of the HDPE composition.

### Polymerization Process

In general, the linear low density polyethylene used in this invention may be prepared in any polymerization process. A solution polymerization process is especially suitable.

Solution processes for the copolymerization of ethylene and an alpha olefin having from 3 to 12 carbon atoms are well known in the art. These processes are conducted in the presence of an inert hydrocarbon solvent typically a C₅₋₁₂ hydrocarbon which may be unsubstituted or substituted by a C₁₋₄ alkyl group, such as pentane, methyl pentane, hexane, heptane, octane, cyclohexane, methylcyclohexane and hydrogenated naphtha. An example of a suitable solvent which is commercially available is “Isopar E” (C₈₋₁₂ aliphatic solvent, Exxon Chemical Co.).

In one embodiment, the solution polymerization process uses at least two polymerization reactors. The polymer solution exiting from the first reactor is preferably transferred to the second polymerization (i.e. the reactors are most preferably arranged “in series” so that polymerization in the second reactor occurs in the presence of the polymer solution from the first reactor).

The polymerization temperature in the first reactor is from about 80° C. to about 180° C. (preferably from about 120° C. to 160° C.) and the second reactor is preferably operated at a slightly higher temperature. Cold feed (i.e. chilled solvent and/or monomer) may be added to both reactors or to the first reactor only. The polymerization enthalpy heats the reactor. The polymerization solution which exits the reactor may be more than 100° C. hotter than the reactor feed temperature. The reactors are preferably well mixed. Suitable pressures are from about 500 psi to 8,000 psi. The most preferred reaction process is a “medium pressure process”, which means that the pressure in each reactor is preferably less than about 6,000 psi (about 42,000 kiloPascals or kPa), and most preferably from about 700 psi to 3,000 psi (about 14,000-22,000 kPa).

Suitable monomers for copolymerization with ethylene include C₃₋₁₂ alpha olefins which are unsubstituted or substituted by up to two 01.6 alkyl radicals. Illustrative non-limiting examples of such alpha-olefins are one or more of propylene, 1-butene, 1-pentene, 1-hexene, 1-octene and 1-decene. Octene-1 is highly preferred.

The monomers are dissolved/dispersed in the solvent either prior to being fed to the first reactor (or for gaseous monomers the monomer may be fed to the reactor so that it will dissolve in the reaction mixture). Prior to mixing, the solvent and monomers are generally purified to remove potential catalyst poisons such as water, oxygen or other polar impurities. The feedstock purification follows standard practices in the art, e.g. molecular sieves, alumina beds and oxygen removal catalysts are used for the purification of monomers. The solvent is preferably treated in a similar manner. The feedstock may be heated or cooled prior to feeding to the first reactor. Additional monomers and solvent may be added to the second reactor, and it may be heated or cooled.

Generally, the catalyst components may be premixed in the solvent for the reaction or fed as separate streams to each reactor. In some instances premixing may be desirable to provide a reaction time for the catalyst components prior to entering the reaction. Such an “in line mixing” technique is described the patent literature (most notably U.S. Pat. No. 5,589,555, issued Dec. 31, 1986 to. DuPont Canada Inc.).

The residence time in each reactor will depend on the design and the capacity of the reactor. Generally the reactors should be operated under conditions to achieve a thorough mixing of the reactants. In one embodiment, from about 20 to about 60 weight % of the final polymer is polymerized in the first reactor, with the balance being polymerized in the second reactor. The multi reactor process described in U.S. Pat. No. 8,101,693 is suitable for the preparation of the polyethylenes used in the present invention. It should also be noted that the examples illustrate a post reaction blend of the linear low density polyethylene with the high density polyethylene and nucleating agent. However, it is also within the scope of this invention to employ a blend of the linear low density polyethylene and high density polyethylene that is prepared in situ (i.e. in one or more polymerization reactors, as described in U.S. Pat. No. 6,984,695).

### C. Nucleating Agents

The term nucleating agent, as used herein, is meant to convey its conventional meaning to those skilled in the art of preparing nucleated polyolefin compositions, namely an additive that changes the crystallization behavior of a polymer as the polymer melt is cooled.

A review of nucleating agents is provided in U.S. Pat. Nos. 5,981,636; 6,465,551 and 6,599,971.

Examples of conventional nucleating agents which are commercially available and in widespread use as polypropylene additives are the dibenzylidene sorbital esters (such as the products sold under the trademark Millad™ 3988 by Milliken Chemical and Irgaclear™ by Ciba Specialty Chemicals).

The nucleating agents should be well dispersed in the HDPE. The amount of nucleating agent used is comparatively small—from 200 to 10,000 parts by million per weight (based on the weight of the HDPE) so it will be appreciated by those skilled in the art that some care must be taken to ensure that the nucleating agent is well dispersed. It is preferred to add the nucleating agent in finely divided form (less than 50 microns, especially less than 10 microns) to the polyethylene to facilitate mixing. The use of a “masterbatch” of the nucleator (where the term “masterbatch” refers to the practice of first melt mixing the additive—the nucleator, in this case—with a small amount of HDPE resin—then melt mixing the “masterbatch” with the remaining bulk of the HDPE resin) can also help to disperse the nucleating agent.

Examples of nucleating agents which may be suitable for use in the present invention include the cyclic organic structures disclosed in U.S. Pat. No. 5,981,636 (and salts thereof, such as disodium bicyclo [2.2.1] heptene dicarboxylate); the saturated versions of the structures disclosed in U.S. Pat. No. 5,981,636 (as disclosed in U.S. Pat. No. 6,465,551; Zhao et al., to Milliken); the salts of certain cyclic dicarboxylic acids having a hexahydrophtalic acid structure (or “HHPA” structure) as disclosed in U.S. Pat. No. 6,598,971 (Dotson et al., to Milliken); phosphate esters, such as those disclosed in U.S. Pat. No. 5,342,868 and those sold under the trade names NA-11 and NA-21 by Asahi Denka Kogyo and metal salts of glycerol (especially zinc glycerolate). The accompanying examples illustrate that the calcium salt of 1,2-cyclohexanedicarboxylic acid, calcium salt (CAS registry number 491589-22-1) provides exceptionally good results. The nucleating agents described above might be described as “organic” (in the sense that they contain carbon and hydrogen atoms) and to distinguish them from inorganic additives such as talc and zinc oxide. Talc and zinc oxide are commonly added to polyethylene (to provide anti-blocking and acid scavenging, respectively) and they do provide some limited nucleation functionality.

The “organic” nucleating agents described above are generally better (but more expensive) nucleating agents than inorganic nucleating agents. In an embodiment, the amount of organic nucleating agent is from 200 to 2000 parts per million.

### Test Procedures Used in the Examples are Briefly Described Below

1. Melt Index: “12”, was determined according to ASTM D1238. [Note: 12 measurements are made with a 2.16 kg weight at 190° C.] Test results are reported in units of grams/10 minutes, or alternatively, decigrams/minute (dg/min).
2. Number average molecular weight (Mn), weight average molecular weight (Mw) and MWD (calculated by Mw/Mn) were determined by high temperature Gel Permeation Chromatography “GPC” with differential refractive index “DRI” detection using universal calibration.
3. Secant Modulus 1% and 2%, machine direction (MD) and transverse direction (TD), was determined according to ASTM D882.
4. Density was determined using the displacement method according to ASTM D792.
5. Gloss was determined by ASTM D2457.
6. Haze was determined by ASTM D1003.

### Film Preparation

This illustrates the preparation of plastic films according to this invention. The films were prepared on a blown film line manufactured by Gloucester Engineering Corporation of Gloucester, Mass. The blown film line was fitted with a single screw extruder having a 2.5″ (6.35 cm) diameter screw, a 24:1 length/diameter screw ratio and an annular die having a 4″ (10.16 cm) diameter. The die gap and output of film conversion were set at 35 mil and 100 lb/hr respectively.

The polyethylenes used in this example were all prepared in a dual reactor solution polymerization process using a single site polymerization catalyst. The linear low density polyethylene used in all examples is an ethylene-octene copolymer having a melt index, I₂, of about 0.7, a density of about 0.916 g/cc, a CDBI of greater than 70%, an Mw/Mn of about 2.8 and was prepared in substantial accordance with the procedures described in U.S. Pat. No. 6,372,864.

Two different HDPEs were used. Both were prepared in a dual reactor polymerization process using a single site catalyst using procedures in substantial accordance with those described in U.S. Pat. No. 7,737,220.

s-HDPE-1 is an ethylene-octene copolymer having a density of 0.953 g/cc, a melt index, 12, of about 1, an Mw/Mn of about 8 and a CDBI of greater than 80%.

s-HDPE-2 is an ethylene homopolymer having a density of 0.967 g/cc, a melt index of about 1.2, an Mw/Mn of about 8 and a CDBI of 100% (note: by convention, homopolymers are deemed to have a CDBI of 100%).

Both of sHDPE-1 and sHDPE-2 include a high molecular weight blend component having an Mw/Mn of about 2 and a low molecular weight blend component.

For convenience, some of the physical properties of sHDPE-1; sHDPE-2 and sLLDPE are provided in Table 1.

TABLE 1
Resin Properties

| Type | Melt Index, dg/min. | Density, g/cc |
|---|---|---|
| sLLDPE-1 | 0.7 | 0.916 |
| sHDPE-1 | 1.0 | 0.953 |
| sHDPE-2 | 1.2 | 0.967 |

### EXAMPLE 1

This example illustrates the preparation of blown films using the above described sLLDPE and sHDPE-1. All films of this example had a thickness of 2 mils. Inventive films further contain a nucleating agent (sold under the trademark HPN 20E by Milliken Chemicals). A total of 10 different blown films were prepared in this example. The first control film (1-C in Table 2) was prepared using 100% of sLLDPE-1 and no nucleating agent. As shown in Table 2, this film has low values for all four modulus tests (at 1% and 2% in both the Machine Direction, MD, and Transverse Direction, TD).

Films 2, 3, and 4 show the effect of adding sHDPE-1 to sLLDPE-1. The modulus values of these films increased with increasing amounts of sHDPE-1. These films are comparative because they do not contain nucleating agent.

Inventive films 5-7 were prepared using a masterbatch (prepared with the nucleating agent and sHDPE-1) that contained 1200 ppm of the nucleating agent. The masterbatch is referred to as MB1 in Table 2. These films show substantial increases in modulus, even though the absolute value of nucleating agent contained in these films is quite small. For example, film 5 contained only 2 weight % of the sHDPE-1 nucleating agent masterbatch and 98 weight % of non-nucleated LLDPE-1 (or a total of only 60 ppm of the nucleating agent, based on the combined weights of the two polyethylenes).

Inventive films 8-10 were prepared by melt mixing sLLDPE-1 and sHDPE-1 (in the amounts shown in Table 2) together with 1200 ppm of the nucleating agent (referred to as NA in Table 2). These films showed large improvements in modulus. Table 3 shows gloss and haze values for the films. Improvements in gloss and haze are an indication that the films are well nucleated.

It is known that the addition of a nucleating agent to HDPE can cause the modulus of the films prepared from the nucleated composition to decrease (in comparison to films that are prepared from non-nucleated HDPE).

Conversely, it is also known that the addition of a nucleating agent to polyethylene can improve (increase) the modulus of films made from the polyethylene. Accordingly, a control experiment was also conducted in which a blend of 1000 ppm of the HPN20E nucleating agent and sLLDPE-1 was used to prepare film. This film had a thickness of 2 mils.

The addition of the nucleating agent was observed to improve haze and gloss by 48% and 33% respectively (in comparison to the non-nucleated film) which is a good indicator that the film was properly nucleated.

However, the MD modulus was observed to improve by only 7% and 6% (at the 1% and 2% condition, respectively) which shows that the nucleating agent alone does not provide all of the improvements that are observed in the films of this invention.

### EXAMPLE 2

The films in this example used the same linear low density polyethylene as used in Example 1 (sLLDPE-1). The thickness of the films is shown in Table 4 (either 1 mil or 2 mils).

However, a homopolymer was used as the HDPE (sHDPE-2, as described above).

A masterbatch of sHDPE-2 and the nucleating agent was used in the preparation of all of the films of this example. The masterbatch was prepared by melt compounding sHDPE-2 and the nucleating agent in an extruder in amounts sufficient to provide a masterbatch containing 4 weight % of the nucleating agent. This masterbatch was then mixed with sLLDPE-1 in the amounts shown in Table 4 to prepare the films of this example.

The films of this example were prepared on a blown film line in substantially the same manner as the films of Example 1.

However, the films from this Example that were prepared with low amounts of the high density resin contained larger amounts of the nucleating agent (in comparison to the similar films from Example 1). As shown in Table 4, further improvements were observed in the modulus values of the films of this example.

While not wishing to be bound by theory, the results from Tables 2 and 4 might be explained as follows:
1) the sHDPE has a higher freezing temperature than the sLLDPE and, therefore, should be the first polymer to crystallize; and
2) the crystallization of the sLLDPE may be nucleated on the frozen sHDPE.

A comparison of the data in Tables 2 and 4 indicates that further enhancements in modulus are also observed with an increasing amount of the nucleating agent (up to a certain point, at which further nucleating agent does not provide further improvements in modulus). This is in spite of the fact that the addition of the nucleating agent to sLLDPE-1 (in the absence of HDPE) did not produce large improvements in modulus. While not wishing to be bound by theory, it is believed that these results may be explained by a requirement for a minimum value of nucleating agent to optimize the nucleation of the HDPE resin. The nucleating agent is believed to be mobile within the polyethylene melt. Thus, when the sLLDPE and HDPE are melt blended, the nucleating agent that was initially present in the HDPE in an amount sufficient to nucleate the HDPE becomes diluted (i.e. distributed throughout the melt). This problem is mitigated by adding more nucleating agent. In addition, it is believed that this problem might be mitigated by starting with an HDPE/nucleating agent masterbatch (as opposed to a sLLDPE/nucleating agent masterbatch).

TABLE 2

| Set 1, Secant Modulus of 2.0 mil blown films | | | % Improvement | |
|---|---|---|---|---|
| | MD Sec Mod | TD Sec Mod | MD Sec Mod | TD Sec Mod |

| Sample Name | | 1% | 2% | 1% | 2% | 1% | 2% | 1% | 2% |
|---|---|---|---|---|---|---|---|---|---|
| 1-C | SLLDPE-1 Control | 138 | 126 | 164 | 141 | 0.0 | 0.0 | 0.0 | 0.0 |
| 2-C | 98% sLLDPE-1 + 2% sHDPE-1 | 150 | 132 | 168 | 145 | 8.7 | 4.8 | 2.4 | 2.8 |
| 3-C | 95% sLLDPE-1 + 5% sHDPE-1 | 157 | 138 | 186 | 155 | 13.8 | 9.5 | 13.4 | 9.9 |
| 4-C | 90% sLLDPE-1 + 10% sHDPE-1 | 182 | 157 | 214 | 177 | 31.9 | 24.6 | 30.5 | 25.5 |
| 5 | 98% sLLDPE-1 + 2% MBI | 153 | 135 | 177 | 149 | 10.9 | 7.1 | 7.9 | 5.7 |
| 6 | 95% sLLDPE-1 + 5% MBI | 166 | 145 | 202 | 168 | 20.3 | 15.1 | 23.2 | 19.1 |
| 7 | 90% sLLDPE-1 + 10% MBI | 192 | 165 | 243 | 200 | 39.1 | 31.0 | 48.2 | 41.8 |
| 8 | 98% sLLDPE-1 + 2% sHDPE-1 +1200 ppm NA | 168 | 146 | 203 | 170 | 21.7 | 15.9 | 23.8 | 20.6 |
| 9 | 95% sLLDPE-1 + 5% sHDPE-1 +1200 ppm NA | 192 | 165 | 246 | 203 | 39.1 | 31.0 | 50.0 | 44.0 |
| 10 | 90% sLLDPE-1 + 10% sHDPE-1 +1200 ppm NA | 216 | 184 | 277 | 227 | 56.5 | 46.0 | 68.9 | 61.0 |

All modulus values reported in MPA
MBI = masterbatch 1
NA = nucleating agent
C = comparative

TABLE 3
Set 1, Haze and Gloss of 2.0 mil blown films

| | Haze | | Haze | Gloss 45 |
|---|---|---|---|---|
| Sample Name | % | Gloss 45 | % change | % change |
| 1 | 12.0 | 56 | 0.0 | 0.0 |
| 2 | 13.8 | 49 | 15.0 | −12.5 |
| 3 | 14.9 | 46 | 24.2 | −17.9 |
| 4 | 20.4 | 41 | 70.0 | −26.8 |
| 5 | 11.9 | 52 | −0.8 | −7.1 |
| 6 | 10.6 | 59 | −11.7 | 5.4 |
| 7 | 10.1 | 61 | −15.8 | 8.9 |
| 8 | 6.4 | 77 | −46.7 | 37.5 |
| 9 | 6.2 | 81 | −48.3 | 44.6 |
| 10 | 8.3 | 70 | −30.8 | 25.0 |

TABLE 4

| | | MD Sec Mod | | TD Sec Mod | |
|---|---|---|---|---|---|
| | | 1% | 2% | 1% | 2% |
| | Sample Name | MPa | MPa | MPa | MPa |
| | 2.0 mil blown films | | | | |
| 11. | 98% sLLDPE-1 + 2% MB2 | 172 | 150 | 213 | 180 |
| 12. | 97% sLLDPE-1 + 3% MB2 | 184 | 160 | 226 | 190 |
| | 1.0 mil blown films | | | | |
| 13. | sLLDPE-1 Control | 132 | 120 | 148 | 128 |
| 14. | 98% sLLDPE-1 + 2% MB2 | 165 | 144 | 184 | 157 |
| 15. | 97% sLLDPE-1 + 3% MB2 | 175 | 153 | 208 | 175 |

• MB2 = masterbatch

TABLE 5
Set 2, Haze and Gloss of blown films

| | Haze | | Haze | Gloss 45 |
|---|---|---|---|---|
| Sample Name | % | Gloss 45 | % change | % change |
| 2.0 mil blown films | | | | |
| 1 | 12.4 | 54 | 0.0 | 0.0 |
| 11 | 4.8 | 84 | −61.3 | 55.6 |
| 12 | 5.0 | 84 | −59.7 | 55.6 |
| 1.0 mil blown films | | | | |
| 13 | 13.0 | 41 | 0.0 | 0.0 |
| 14 | 4.8 | 78 | −63.1 | 90.2 |
| 15 | 5.0 | 77 | −61.5 | 87.8 |

### INDUSTRIAL APPLICABILITY

It is known that prior art films prepared from polyethylenes that are polymerized with a single site catalyst typically have a soft and flexible feel that results from the low modulus of such polyethylenes. This invention provides a polyethylene composition having a higher modulus which enables the production of films having a stiffer feel. The resulting compositions and films are suitable for use in a wide variety of packaging applications.

1. A method to improve the stiffness of a polyethylene film, said method comprising providing a composition comprising
1) a polyethylene blend comprising
a) from 90 to 98 weight % of a linear low density polyethylene composition that has been prepared with a single site catalyst; and
b) from 10 to 2 weight % of high density polyethylene composition; and
2) from 200 to 10,000 parts per million by weight, based on the weight on said polyethylene blend, of a nucleating agent,
and subjecting said composition to a film molding process, wherein said film has a higher 1% secant modulus than a film that is prepared with said polyethylene blend but in the absence of said nucleating agent.

2. The method of claim 1 wherein said linear low density polyethylene composition has a density of from 0.0905 to 0.935 g/cc.

3. The method of claim 2 wherein said high density polyethylene composition has a density of from 0.95 to 0.97 g/cc.

4. The method of claim 1 wherein said linear low density polyethylene composition consists essentially of polyethylene that was prepared with a single site catalyst.

5. The method of claim 4 wherein said linear low density polyethylene composition has an Mw/Mn of from 2 to 4.

6. The method of claim 1 wherein said film molding process is a blown film molding process.

7. The method of claim 1 wherein said polyethylene blend composition comprises
a) from 95 to 98 weight % of said linear low density polyethylene composition, and
b) from 2 to 5 weight % of said high density polyethylene composition.

8. A composition comprising:
1) a polyethylene blend comprising:
a) from 90 to 98 weight % of a linear low density polyethylene composition that is prepared with a single site catalyst, wherein said linear low density polyethylene composition has a melt index, 12, of from 0.2 to 10 g/10 minutes and a density of from 0.905 to 0.935 g/cc; and
b) from 10 to 2 weight % of a high density polyethylene composition, wherein said high density polyethylene composition has a melt index, 12, of from 0.1 to 10 g/10 minutes and a density of from 0.95 to 0.97 g/cc; and
2) from 200 to 10,000 parts per million by weight, based on the weight of said polyethylene blend, of a nucleating agent.

9. The composition of claim 8 wherein said linear low density polyethylene composition has an Mw/Mn of from 2 to 4.

10. The composition of claim 8 wherein said polyethylene blend composition comprises: a) from 95 to 98 weight% of said linear low density polyethylene composition, and
b) from 2 to 5 weight% of said high density polyethylene composition.
